(19) United States
(12) Patent Application Publication
(10) Pub. No.: US 2020/0133248 A1
(43) Pub. Date: Apr. 30, 2020

(54) SYSTEM AND METHOD FOR INVERSE INFERENCE FOR A MANUFACTURING PROCESS CHAIN

(71) Applicant: Tata Consultancy Services Limited, Mumbai (IN)

(72) Inventors: Avadhut Mohanrao SARDESHMUKH, Pune (IN); Sapankumar Hiteshchandra SHAH, Pune (IN); Sreedhar Sannareddy REDDY, Pune (IN); Gautham Purushottham BASAVARSU, Pune (IN)

(73) Assignee: Tata Consultancy Services Limited, Mumbai (IN)

(21) Appl. No.: 16/562,858

(22) Filed: Sep. 6, 2019

(30) Foreign Application Priority Data
Oct. 26, 2018 (IN) 201821040561

(51) Int. Cl. G05B 19/418; G06N 7/00; G06N 5/02; G06N 20/00

(52) U.S. Cl. CPC G05B 19/41865; G06N 7/005; G05B 2219/32365; G06N 20/00; G05B 2219/34082; G06N 5/02

(57) ABSTRACT

The present disclosure provides a system and method for inverse inference in a chain of manufacturing processes using Bayesian networks is provided. The method generates a composite Bayesian network model for a chain of manufacturing processes from Bayesian network models of the unit processes in the chain. The models of unit processes might have been learned independently in other contexts and stored in a knowledge repository. Models relevant for the current problem context are obtained from the knowledge repository and checked for compatibility using ontological information about their inputs and outputs. The obtained compatible Bayesian network models of unit processes are composed to generate a composite Bayesian network model for the chain. The generated composite Bayesian network model is sampled to perform inverse inference.

### CROSS-REFERENCE TO RELATED APPLICATIONS AND PRIORITY

This U.S. patent application claims priority under 35 U.S.C. § 119 to Indian Application No. 201821040561, filed on Oct. 26, 2018. The entire contents of the abovementioned application are incorporated herein by reference.

### TECHNICAL FIELD

The disclosure herein generally relates to the field of integrated computation materials engineering, and, more particularly, but not specifically, a system and method for predicting configuration of a manufacturing process chain for a desired output.

### BACKGROUND

Integrated Computational Materials Engineering (ICME) is a new approach to the design and development of materials, manufacturing processes and products. It proposes using a combination of physics based simulations, data driven reasoning and guided experiments to speed up the development of new materials and manufacturing processes by integrating material design with product design.

A large design space consisting of combinations of material compositions, processes and their parameters needs to be explored. An important problem in this context is to model the relationships between a material's structure, processes and properties. Specifically, prediction of outputs/properties given the processing parameters (forward prediction problem) and prediction of inputs/process parameters required to achieve desired outputs/properties (inverse prediction problem) are problems which need to be addressed.

An alternative is to use fast and approximate data-driven models learnt from data generated from carefully designed limited number of expensive simulations. Hence, inverse prediction model is useful in problems with large design spaces, for narrowing down the design space so that expensive simulations and experiments could be used to explore the narrowed down design space.

### SUMMARY

Embodiments of the present disclosure present technological improvements as solutions to one or more of the above-mentioned technical problems recognized by the inventors in conventional systems. For example, in one embodiment, a system to predict a configuration of a manufacturing process for desired properties of a product is provided.

The system includes at least one memory with a plurality of instructions and one or more hardware processors communicatively coupled with the at least one memory to execute modules. Further, the system comprises a receiving module, a description module, a learning module, a selection module, an obtaining module, a validation module, and a generation module. The receiving module is configured to receive a description of a plurality of unit manufacturing processes of the manufacturing process and a set of desired output properties from the manufacturing process. The description module is configured to create an ontological description of the plurality of unit manufacturing processes and its one or more parameters. The learning module is configured to learn a plurality of Bayesian network models for each of the plurality of unit manufacturing processes, wherein the learned plurality of Bayesian network models are stored in a knowledge depository. The selection module of the system selects two or more unit manufacturing processes of the plurality of unit manufacturing processes. The obtaining module of the system is configured to obtain the learned Bayesian network model corresponding to each of the selected two or more unit manufacturing processes from the knowledge repository. The validation module of the system is configured to validate compatibility among the obtained set of Bayesian network models corresponding to each unit manufacturing process using a set of predefined rules. Finally, generating a composite model at the generation module of the system using compatible Bayesian network model corresponding to each of the two or more selected unit manufacturing processes. Herein, the generated composite model is used to predict the configuration of the plurality of unit manufacturing processes and the generated composite model is sampled using a Monte Carlo simulation to infer configuration for desired properties of a product to be manufactured.

In another aspect, a processor-implemented method to predict a configuration of a manufacturing process for desired properties of a product is provided. The method includes one or more steps such as receiving a description of a plurality of unit manufacturing processes of the manufacturing process and a set of desired output properties from the manufacturing process, creating an ontological description of the plurality of unit manufacturing processes and its one or more parameters, learning a plurality of Bayesian network models for each of the plurality of unit manufacturing processes, wherein the learned plurality of Bayesian network models are stored in a knowledge depository, selecting two or more unit manufacturing processes of the plurality of unit manufacturing processes, obtaining the learned Bayesian network model corresponding to each of the selected two or more unit manufacturing processes from the knowledge repository, validating compatibility among the obtained each of the Bayesian network model corresponding to each of the selected two or more unit manufacturing processes using a set of predefined rules and generating a composite model using compatible Bayesian network model corresponding to each of the two or more selected unit manufacturing processes to predict the configuration of the plurality of unit manufacturing processes, wherein the composite model is sampled to infer configuration for desired properties of the product to be manufactured.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system to predict a configuration of a manufacturing process for desired properties of a product, according to some embodiments of the present disclosure.

FIG. 2 is a schematic diagram, as an example, to describe a gear design manufacturing process according to an embodiments of the present disclosure.

FIGS. 3A and 3B are a flow diagram to illustrate a method to predict a configuration of a chain of a manufacturing process for desired properties of a product in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

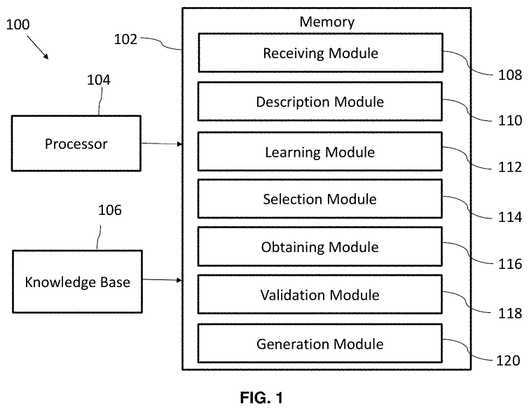

Referring now to the drawings, and more particularly to FIG. 1 through 3B, where similar reference characters denote corresponding features consistently throughout the figures, there are shown exemplary embodiments and these embodiments are described in the context of the following exemplary system and/or method.

Referring FIG. 1, a system (100) to predict a configuration of a manufacturing process for desired properties of a product is provided. Further herein, the system is configured for an inverse inference of a chain of manufacturing process to predict the configuration of the chain of the manufacturing processes for the desired properties of the product. A variant of the conditional Linear Gaussian Bayesian network to be used. As all the variables (process parameters and properties) being modeled are continuous variables, a Bayesian network variant that supports continuous distributions is needed. Further, the system comprises a model capable of representing non-linear relationships by learning piecewise linear approximations.

In an exemplary embodiment, the system (100) comprises at least one memory (102) with a plurality of instructions and one or more hardware processors (104) which are communicatively coupled with the at least one memory (102) to execute modules therein. The system comprises a knowledge base (106), a receiving module (108), a description module (110), a learning module (112), a selection module (114), an obtaining module (116), a validation module (118), and a generation module (120).

The knowledge base (106) of the system is associated with the one or more hardware processors (104). The knowledge base (106) includes data utilized for the functioning of the system (100). It will be understood that although the knowledge base (106) has been shown external to the system (100), however, the knowledge base (106) may be located within the system (100).

In one aspect, the knowledge base (106) includes the data, such as knowledge elements in the form of ontology instances of a plurality of ontologies. Further, the knowledge base (106) may include material knowledge elements, product and process knowledge elements, and models knowledge elements organized as rules, cases, equation, models and so on, all expressed in terms of the common vocabulary provided by an ontology. In another implementation, a specification mechanism may be provided to compose knowledge elements spanning multiple knowledge representation mechanisms, such as rules, cases, equations, models and so on, and using domain ontology as a means to integrate reasoning across these mechanisms.

In one exemplary embodiment, the receiving module (108) of the system (100) is configured to receive a description of a plurality of unit manufacturing processes of the manufacturing process and a set of desired output properties from the manufacturing process. It is to be noted that the chronological order of the plurality unit manufacturing processes must be defined in the received description to achieve the set of desired output properties from the manufacturing process.

It will be appreciated that selection of materials for product manufacturing plays a pivotal role in the process of developing a new product. The chemistry and internal structure of materials have significant effect on various properties, such as strength of the product. Thus, selecting or designing a suitable material for the product required careful attention. Further, apart from selecting and/or designing the material, processing of the material may result in variation in properties of the material. For instance, same material when heated at different temperatures may attain different properties, such as strength, impact resistance, fatigue life, and surface texture. Thus, developing a new product may become a time consuming and cost intensive due to designing of the new material and their processing techniques as such designing involves various experiments and trials. Hence, the system(s) and method(s) are based on domain knowledge of materials, processing techniques, i.e., material manufacturing and processing methods, internal structure of material, material properties, and products developed using the material.

In an exemplary embodiment, the description module (110) of the system (100) is configured to create an ontological description of the plurality of unit manufacturing processes and its one or more parameters from the received description of the plurality of unit manufacturing processes.

An ontology defines a common vocabulary for users who share information within a domain. The domain may be understood as a field of knowledge, for example, materials and process may be the domain in the present case of material and process designing. The ontologies are typically defined using various ontology instances which includes machine interpretable and human readable definitions of basic concepts of the domain and the relations among these basic concepts.

In one aspect, the domain knowledge is organized in the form of knowledge elements, interchangeably referred to as knowledge, and ontologies stored in knowledge database, interchangeably referred as knowledge base. Providing the ontologies helps in ensuring that all data, such as properties and parameters related to materials and process are available directly. Further, capturing associations between various entities, such as the materials and the processes, and the material properties and the internal structure of material helps in identifying suitable materials and process for developing a product. Additionally, such associations may further help in designing new materials and processes. Further, combining the ontology based knowledge database, simulation models, online databases, and the system for real time processing and updating of the knowledge base helps in providing an integrated framework for the manufacturing process.

In another aspect, knowledge corresponding to material, product and process, and simulation models may be organized as rules, cases, equation, models and so on, expressed in terms of the common vocabulary provided by the ontology. Further, a specification mechanism may be provided to compose knowledge elements spanning multiple knowledge representation mechanisms, such as rules, cases, equations, models and so on, and using domain ontology as a means to integrate reasoning across these mechanisms. As will be understood, ontology refers to a common vocabulary for people who need to share information within a domain. The ontology contains machine-interpretable and human readable definitions, called ontology instances, of basic concepts of the domain and the relations among these basic concepts. The ontology instances, in one example, may be created using a resource description framework (RDF)-web ontology language (OWL) schema. In one example, three types of ontologies, namely, material ontology, product and process ontologies, model ontology and the relationships between these ontologies are used.

Material ontology describes the concepts related to the internal structure, composition, form and properties of a material. Materials may be understood as different materials, such as steel, aluminum, wood, plastic, that may be used for manufacturing a product and may be further classified into form of material, such as bar, sheet, powder, pellets, and billet and state of material, such as solid, liquid, and gaseous. Material properties may be understood as properties of the materials, such as strength and corrosion resistance and may be further classified into mechanical, physical, thermal, chemical, electrical, biological, etc. Internal structure of the material may include, for example, bulk phases, such as Ferrite, Martensite, Austenite, Cementite, Pearlite, and Bainite inclusions; dislocations; and precipitates in the case of steels. Each of these bulk phases may have attributes, such as sub-phases, phase composition, phase percentage, and phase distribution and may be associated with morphology, such as lath and plate, atomic arrangement, such as crystalline and amorphous. The material ontology instance further captures relationships between the materials, the internal structure of material, and the material properties.

For instance, it may capture what all properties and internal structure of material may be associated with a particular material and the relationship between these entities. The material ontology instance thus helps in providing data about materials using which materials suitable for a product may be identified, for example, by the system and a product engineer using the system. Further, providing relationship between the materials, the material properties, and the internal structure of material may help in identifying compositions and internal structures.

Product and process ontology instance includes data related to various products that may be manufactured using the materials and various processing techniques that may be carried out for manufacturing of the material and the product. Product data may include product related information, such as geometry, weight, volume, area, and strength that may be useful for developing the product and also identifying materials and the process for manufacturing the product. Further, processing techniques may be classified into primary manufacturing techniques, shaping processes, fabrication processes, etc. Model ontology instance includes various simulation and approximation models on a variety of phenomena at different levels of precision that may be used for testing materials and products in simulated real time environments.

Based on the properties and the requirements of the products, suitable materials, i.e., materials meeting requirements of the products may be ascertained using material knowledge elements and the material ontology instance. For example, based on the product requirements, a set of material selection rules may be determined from the material knowledge elements for ascertaining a suitable steel material, such as a rod, or a sheet of a particular strength, grade, etc. Subsequently, the material may be processed using one or more processes determined using product and process knowledge elements and the process ontology instances. The product and process knowledge elements may include a set of rules or a decision tree using which the product and process ontology instance may be determined and used.

In yet another aspect, the system (100) may initially identify the requirements and desired properties of the product based on the received description of a plurality of unit manufacturing processes and process ontology instance and product and process knowledge elements. The system (100) may subsequently determine suitable materials, i.e., materials meeting requirements of the products using the material ontology instance and the product and process knowledge elements. Additionally, a regular update of the knowledge base also ensures that the system (100) has access to all types of material and processes available till data for developing a product, a manufacturing material, or a processing technique.

In one exemplary embodiment, the learning module (112) of the system (100) is configured to learn a plurality of Bayesian network models for each of the plurality of unit manufacturing processes based on the created ontological description. It will be appreciated that the learned plurality of Bayesian network models are stored in the knowledge base (106). Each Bayesian network model for a corresponding unit manufacturing process, which may be unit operations in other larger processes, is learnt independently from data and stored in the knowledge base (106).

In a Bayesian network model a network construction component takes a list of variables as an input and influence relations among the list of variables. From the list of variables, the network construction component constructs a Bayesian network where edges represent the influence relations. The structure and parameters of the Bayesian network are learnt from a training component. The training component assumes a conditional linear Gaussian for example. Each continuous node of the Bayesian network has a mixture of Gaussians distribution, wherein, the mixture distribution has one component for each value of discrete parents, and wherein, each component of the mixture distribution is a Gaussian whose mean is a linear combination of the values taken by its parents. The training component applies maximum likelihood estimation algorithm on the data to estimate the coefficients in this linear function for each node. Variance of each node is learnt separately from the data.

In an exemplary embodiment, the selection module (114) of the system (100) is configured to select two or more unit manufacturing processes of the plurality of unit manufacturing processes for the desired properties of a product.

In one exemplary embodiment, the obtaining module (116) of the system (100) is configured to obtain the learned Bayesian network model corresponding to each of the selected two or more unit manufacturing processes from the knowledge base (106).

In an exemplary embodiment, the validation module (118) of the system (100) is configured to validate compatibility among the obtained each of the Bayesian network model corresponding to each of the selected two or more unit manufacturing processes using a set of predefined rules.

It will be appreciated that the Bayesian network model corresponding to each of the selected two or more unit manufacturing processes are compatible if the output of first Bayesian network model is ontologically compatible to the input of the second Bayesian network model. This means the ontological type of the output variable of the first ontological network model is either be the same as that of the input variable to the second ontological network model or the output of first Bayesian network model is a specialization of the input to the second Bayesian network model. The Bayesian network models are compatible in such a case because the second ontological network model that can handle inputs from a certain set can definitely handle inputs from its subset only.

In an exemplary embodiment, the generation module (120) of the system (100) is configured to generate a composite model using compatible Bayesian network model corresponding to each of the two or more selected unit manufacturing processes to predict the configuration of the plurality of unit manufacturing processes, wherein the composite model is sampled to infer configuration for desired properties of the product to be manufactured.

It is to be noted that when at least two Bayesian network models and a mapping between outputs of first Bayesian network model and inputs of the second Bayesian network model is completed, it generates a model named as a composite model. Wherein the composite model is created and probability distributions are copied from the original models.

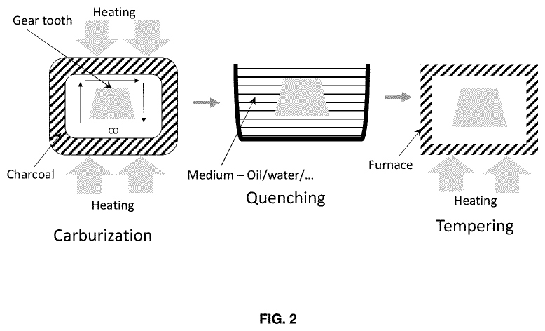

Referring FIG. 2, as an example, a typical gear manufacturing process consisting of the carburization-quenching-tempering as unit manufacturing processes is illustrated. In this process-chain, the initial material is first heated (carburization), then kept in a carbon-rich environment (diffusion), then rapidly cooled by quenching in a medium such as oil or water and finally heat-treated (tempering) again. The complete manufacturing process along with input and output at each unit manufacturing process is shown in FIG. 2. It will be appreciated that some of the outputs of carburization represent the state of the material after carburization, which is fed to the diffusion process, which is the next one in a predefined sequence. These outputs are carbon percentage at pitch and root, and depth of 85% Carbon at pitch and root. Hence, these output of the carburization act as inputs to the diffusion process.

Bayesian network models is selected for each unit manufacturing process as carburization, diffusion, quench, and temper and obtained them from knowledge repository since they are relevant in the given context of the gear manufacturing. A composite model for the gear manufacturing is generated by mapping the nodes of two Bayesian network models. It is to be noted that in each manufacturing process the chronological order of each unit manufacturing process must be predefined as per requirement of the product. Herein, the Bayesian network model of the carburization and the Bayesian network model of the diffusion must be compatible because they are in a predefined chronological order to achieve a gear. The output of the Bayesian network model of the carburization is mapped with the input of the Bayesian network model of the diffusion. It is found that the variables of CPC, CRC, CDPC, and CDRC in both the Bayesian network models map to the same ontological elements. Therefore, a composite model is generated with all variables of each Bayesian network model of each unit manufacturing process of the gear manufacturing.

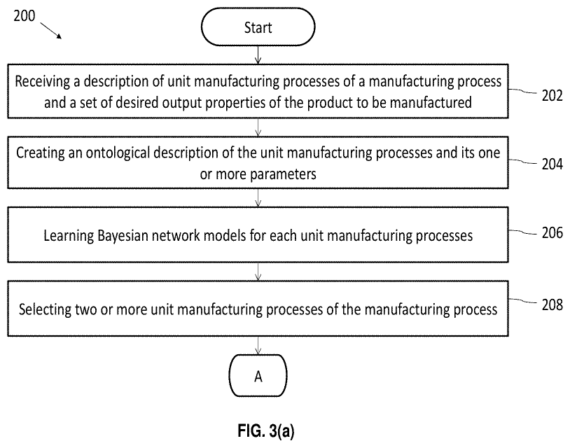

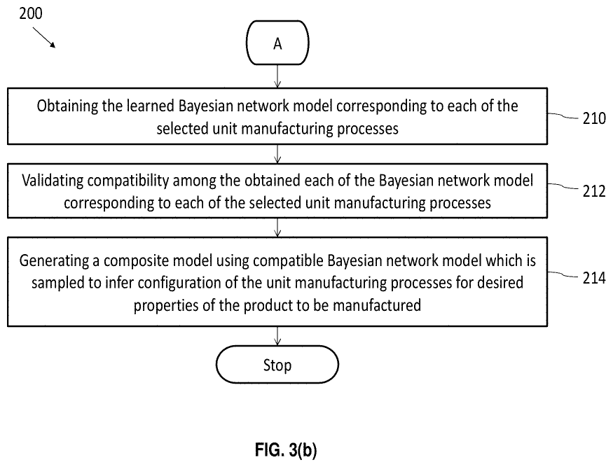

FIGS. 3A and 3B depict a method (200) to predict a configuration of a manufacturing process for desired properties of a product. The order in which the method is described is not intended to be construed as a limitation, and any number of the described method steps can be combined in any order to implement the method (200) or any alternative methods. Additionally, individual steps may be deleted from the method without departing from the spirit and scope of the subject matter described herein. Furthermore, the methods can be implemented in any suitable hardware, software, firmware, or combination thereof.

The method(s) may be described in the general context of computer executable instructions. Generally, computer executable instructions can include routines, programs, objects, components, data structures, procedures, modules, functions, etc. that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the methods can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary methods.

Initially, at step (202), a description of a plurality of unit manufacturing processes are received at a receiving module (108) of the system (100). Further herein, a set of desired output properties of the product to be manufactured are also received at a receiving module (100) of the system (100).

In one exemplary embodiment, at step (204), an ontological description of each of the plurality of unit manufacturing processes and its one or more parameters is created at a description module (108) of the system (100).

In an exemplary embodiment, at step (206), a plurality of Bayesian network models for each of the plurality of unit manufacturing processes are learned at a learning module (112) of the system (100) and the learned plurality of Bayesian network models are stored in a knowledge base.

In one exemplary embodiment, at step (208), selecting two or more unit manufacturing processes of the plurality of unit manufacturing processes at a selection module (114) of the system (100).

In an exemplary embodiment, at step (210), the learned Bayesian network model is obtained at an obtaining module (116) of the system (100) corresponding to each of the selected two or more unit manufacturing processes from the knowledge base.

In one exemplary embodiment, at the step (212), compatibility among the obtained each of the Bayesian network model corresponding to each of the selected two or more unit manufacturing processes is validated at a validation module (118) of the system (100) using a set of predefined rules.

Finally, at the step (214), a composite model is generated at a generation module (120) of the system (100) using compatible Bayesian network model corresponding to each of the two or more selected unit manufacturing processes to predict the configuration of the plurality of unit manufacturing processes. Whenever, the composite model is sampled, it infers the configuration of the plurality of unit manufacturing processes for the desired properties of the product to be manufactured.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of prediction of outputs/properties given the processing parameters (forward prediction problem) and prediction of inputs/process parameters required to achieve desired outputs/properties of a product. Moreover, the embodiments herein further provides a system and method to predict a configuration of a manufacturing process for desired properties of the product. Further herein, the system is configured for an inverse inference of a chain of manufacturing process to predict the configuration of the chain of the manufacturing processes for the desired properties of the product. A variant of the conditional Linear Gaussian Bayesian network to be used. As all the variables (process parameters and properties) being modeled are continuous variables, a Bayesian network is needed for continuous variables. Further, the system comprises a model capable of representing non-linear relationships and the model is capable of learning piecewise linear approximations.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor-implemented method to predict configuration of a manufacturing process for desired properties of a product, the method comprising:
receiving a description of a plurality of unit manufacturing processes of the manufacturing process and a set of desired output properties from the manufacturing process;
creating an ontological description of the plurality of unit manufacturing processes and its one or more parameters;
learning a plurality of Bayesian network models for each of the plurality of unit manufacturing processes, wherein the learned plurality of Bayesian network models are stored in a knowledge depository;
selecting two or more unit manufacturing processes of the plurality of unit manufacturing processes;
obtaining the learned Bayesian network model corresponding to each of the selected two or more unit manufacturing processes from the knowledge repository;
validating compatibility among the obtained each of the Bayesian network model corresponding to each of the selected two or more unit manufacturing processes using a set of predefined rules; and
generating a composite model using compatible Bayesian network model corresponding to each of the two or more selected unit manufacturing processes to predict the configuration of the plurality of unit manufacturing processes, wherein the composite model is sampled to infer configuration for desired properties of the product to be manufactured.

2. The method claimed in claim 1, wherein the ontology description includes semantic description for each of the plurality of unit manufacturing processes and its corresponding parameters.

3. The method claimed in claim 1, wherein the plurality of unit manufacturing processes are in a predefined chain.

4. The method claimed in claim 1, wherein the plurality of unit manufacturing processes include carburization, quenching and tempering.

5. The method claimed in claim 1, wherein the output of the first unit manufacturing process of the predefined chain is the input to the second unit manufacturing process of the predefined chain.

6. The method claimed in claim 1, wherein the value range of the output of the first unit manufacturing process of the predefined chain is same as value range of input to the second unit manufacturing process of the predefined chain.

7. The method claimed in claim 1, wherein the output of the first unit manufacturing process of the predefined chain is a generalization of the input to the second unit manufacturing process of the predefined chain.

8. The method claimed in claim 1, wherein the generated composite model is a Bayesian network model for the predefined chain obtained by appending successive Bayesian network model of each unit manufacturing process of the plurality of unit manufacturing processes.

9. A system configured to predict a configuration of a manufacturing process for desired properties of a product, the system comprising:
at least one memory storing instructions; and
one or more hardware processors communicatively coupled with the at least one memory, wherein the one or more hardware processors are configured to execute the instructions to:
receive a description of a plurality of unit manufacturing processes of the manufacturing process and a set of desired output properties from the manufacturing process;
create an ontological description of the plurality of unit manufacturing processes and its one or more parameters;
learn a plurality of Bayesian network models for each of the plurality of unit manufacturing processes, wherein the learned plurality of Bayesian network models are stored in a knowledge depository;
select two or more unit manufacturing processes of the plurality of unit manufacturing processes;
obtain the learned Bayesian network model corresponding to each of the selected two or more unit manufacturing processes from the knowledge repository;
validate compatibility among the obtained each of the Bayesian network model corresponding to each of the selected two or more unit manufacturing processes using a set of predefined rules; and
generate a composite model using compatible Bayesian network model corresponding to each of the two or more selected unit manufacturing processes to predict the configuration of the plurality of unit manufacturing processes, wherein the composite model is sampled to infer configuration for desired properties of the product to be manufactured.

10. The system claimed in claim 8, wherein the ontology description includes semantic description for each of the plurality of unit manufacturing processes and its corresponding parameters.

11. The system claimed in claim 8, wherein the plurality of unit manufacturing processes are in a predefined chain.

12. The system claimed in claim 8, wherein the plurality of unit manufacturing processes include carburization, quenching and tempering.

13. The system claimed in claim 8, wherein the output of the first unit manufacturing process of the predefined chain is the input to the second unit manufacturing process of the predefined chain.

14. The system claimed in claim 8, wherein the value range of the output of the first unit manufacturing process of the predefined chain is same as value range of input to the second unit manufacturing process of the predefined chain.

15. The system claimed in claim 8, wherein the output of the first unit manufacturing process of the predefined chain is a generalization of the input to the second unit manufacturing process of the predefined chain.

16. The system claimed in claim 8, wherein the generated composite model is a Bayesian network model for the predefined chain obtained by appending successive Bayesian network model of each unit manufacturing process of the plurality of unit manufacturing processes.
